(19) United States
(12) Patent Application Publication
(10) Pub. No.: US 2015/0262091 A1
(43) Pub. Date: Sep. 17, 2015

(54) TRAVEL MANAGEMENT DEVICE OF TRANSPORT VEHICLE

(71) Applicant: Hitachi Construction Machinery Co., Ltd., Tokyo (JP)

(72) Inventors: Shohei Yamagata, Setagaya (JP); Rikiya Tajiri, Matsudo (JP); Yuki Hara, Ota (JP); Yoshimi Kasai, Nagareyama (JP); Tsugumichi Owaki, Koto (JP); Hiroshi Yoshikawa, Ota (JP); Takayuki Uchida, Hitachi (JP); Akira Ueno, Ichikawa (JP); Nobuyoshi Hirowatari, Kasumigaura (JP)

(21) Appl. No.: 14/428,193

(22) PCT Filed: Sep. 21, 2012
(86) PCT No.: PCT/JP2012/074210

§ 371 Date: Mar. 13, 2015

(51) Int. Cl. G06Q 10/04; H04L 12/24; G06T 11/20

(52) U.S. Cl. CPC G06Q 10/04; G06T 11/206; H04L 41/22

(57) ABSTRACT

Travel management is adapted to perform of transport vehicle at working areas which are widely different in geographical conditions to ensure operation in a facilitated manner with high efficiency of exhaust gas and at high running efficiency. A signal processor (32) of a management center (30) is processed signals transmitted from sensors provided in a dump truck (2) to create, then on the basis thereof a display (33) is shown graphs respectively expressed in a form of temporal transition on chronological pattern for load of the dump truck (2), inclination on travelling rout of the dump truck 2 and step-in quantity of an accelerator pedal by the operator, thereby ensuring high efficiency of exhaust gas and at high running efficiency by properly operating the acceleration pedal on the basis of comprehensive judgment taking in consideration of the load weight of the dump truck (2) and travelling rout.

### FIELD OF THE INVENTION

The present invention relates to travel management device of transport vehicle for making management of transport vehicle such as a dump truck for transporting excavated substance which is loaded from an excavating machine which is working of excavation in a working field, such as field of mining and the like.

### DESCRIPTION OF THE BACKGROUND ART

For example, in a field of open pit mining, main works are mining work and dressing work of ore. Mining work is to excavate ore contained useful mineral out from a mining field, and dressing work of ore is to dress and extract useful mining material from excavated ore. Mining work is performed to excavate the ground at a place to be presented vein in a mining field, while separating ore is not performed at the working site of the mining area, but is performed at an independent yard which is installed various equipment necessary to dress ore. Earth and sand are covered over the layer of ore, and the earth and sand are not included ore or useful material so that dumping site is provided in order to dump waste earth and sand.

An excavating machine such as a hydraulic excavator is used for mining purpose, and a dump truck as transport vehicle is used to transfer mining ore from the mining field to the ore dumping yard and also to transfer waste earth and sand, rocks and the like to the dumping site. Usually, one excavating machine is combined with three to five dump trucks are provided in combination with one excavating machine depending upon the distance from mining field to the ore dumping yard.

Due to disposition at apart from the excavating field which is placed the excavating machine to the ore dumping site, the dump track is repeatedly travelled from the place at loading of excavated mining ore on the vessel to the ore dumping site for dumping from the vessel at a specific position. The travelling rout of the dump truck is irregular ground, and most of the rout is sloped or inclined ground, thus the road is uphill and downhill repeatedly. Further, the dump truck travels with loaded mining material on one way, that is outward rout, while being empty of the vessel on the return rout.

It is important to set which rout is to be taken for travelling, and to determine travelling speed at the time of hill-ascending travel and hill-descending travel from the point of view to assure travelling safety of the dump truck, to improve efficiency, to improve fuel consumption efficiency and to reduce consumption amount of exhaust gas, in this connection, the travelling condition may vary depending upon the load weight of the dump truck. Therefore, it is essentially necessary to detect precisely the load weight of the dump truck from the point of view of fuel consumption efficiency and the like. Since loaded substance such as mineral substance, earth and sand or the like is loaded from the excavating machine to the vessel of the dump truck, the loaded weight is to be measured after fed the loaded object. For example, patent document 1 discloses to actual loaded weight after loading on a dump truck.

The operator who recognizes the actual loaded weight of the vessel of the dump truck is desirable from the various points of view such as travelling safety, improving fuel consumption efficiency and the like.

### PRIOR ART DOCUMENT

### Patent Document

Patent Publication JP 2005-61984 A1

### SUMMARY OF THE INVENTION

### Problem to be Solved by the Invention

The operating circumstances that a dump truck as a transport machine is operated differ greatly depending upon the geographical condition in the field of mining, the travelling route being irregular ground and the most of the rout consisting of inclined road of moderate or steep slope. Therefore, to measure the actual load weight of the dump truck is important as described in the patent document 1 in order to perform travelling management of the dump truck with improved running stability and efficiency, in addition to improve the ability of driving operation, and to enhance the improvement of fuel consumption efficiency and to suppress exhaust gas in the course of travelling, further necessitating of travelling administration and analysis obtained by information as to the condition of road and travelling speed, and the like.

The present invention is accomplished in light of the foregoing, the object of the present invention is to provide travel management device of transport vehicle for managing transport vehicle such as dump truck, in a situation of transporting loaded substance around a working area which is widely different in geographical condition to travel, so as to ensure operation in a facilitated manner with suppressing exhaust gas consumption for high efficiency, and at high running stability and efficiency.

### Means for Solving the Problem

In order to solve the foregoing problem, the present invention relates to, a travel management device of a transport vehicle at a management center in order to perform management of the transport vehicle having a travelling mechanism and a vessel, the transport vehicle being operated with loaded substance on the vehicle to be reciprocally travelled between a predetermined loading field and unloading field, which comprises: the transport vehicle having at least a load sensor installed in the transport vehicle to measure weight of loaded substance contained in the vessel, inclination sensor to detect inclination angle of the vehicle and an operation amount sensor to detect travelling speed of the vehicle by the operation of a transmission mechanism, further provided with a wireless communication transmitter for transmitting signals detected by the respective sensor; the management center being provided with a wireless communication receiver to receive transmitted signal from the wireless communication transmitter, and a signal processing apparatus to create plural number of sensor data on the basis of output signal from respective sensors adapted to be displayed plural number of graphs respectively expressed in a form of chronological pattern; and further the management center having an image displaying apparatus for displaying on a single screen of plural number of related information on the same time axis.

The displaying apparatus can be shown plural number of sensor data on the same screen upon selection in accordance with the purpose, for example, in a case to improve fuel consumption efficiency as a main object, the display contents are showing on the same time axis of a difference in height along with the travelling rout of the transport vehicle, load weight of the vessel and temporal transition of detection data of the quantity of accelerator operation.

### Effects of the Invention

Travel management can be performed to transport loaded substance by a transport vehicle for ensuring operation with excellent manner at high fuel consumption efficiency and high efficient performance, even if various operating fields in greatly different geographic condition and the like.

### BRIEF DESCRIPTION OF THE DRAWINGS

FIG. 1 is a schematic diagram to show mining works in mining field in one embodiment of operation by a working machine.

FIG. 2 shows a side elevation view of a dump truck as an example of transport machine consisting of the working machine.

FIG. 3 is a block diagram of one example for operation of travelling management of the dump truck.

FIG. 4 is a block diagram of composition of signal processing apparatus installed in a management center provided in a mining field.

FIG. 5 is an explanatory drawing of an image shown on a image display member.

### EMBODIMENT OF THE INVENTION

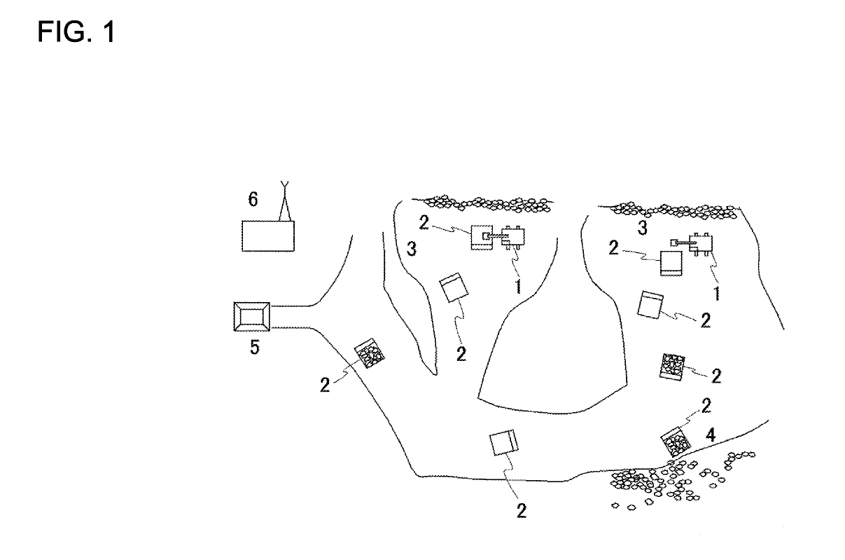

Hereafter, embodiments of the present invention will be described with reference to the attached drawings. First of all, FIG. 1 shows a schematic view of all over a field of mining in which a excavating machine 1 and dump truck 2 as a transport vehicle are operated. In this figure, 3 denotes the mining field, 4 denotes a dumping site for dumping useless earth and sand, and 5 denotes a dressing site for extracting useful minerals. In this figure, two vein of ore are existing in the mining field 3, thus being operating in respective mining field 3 of a hydraulic excavator as an excavating machine 1, and excavated ore being transferred out from the mining field 3 by means of a dump truck 1. Useless earth and sand is dumped to the dumping site 4 and useful ore is transferred to the dressing site 5 for extraction. Extraction is performed for dressing excavated ore to useful ore from useless ore, relevant equipment such as a crusher is installed in the dressing site 5. Therefore, the mining field is a loading place for the dump truck 2 and the dressing site 5 is a unloading place.

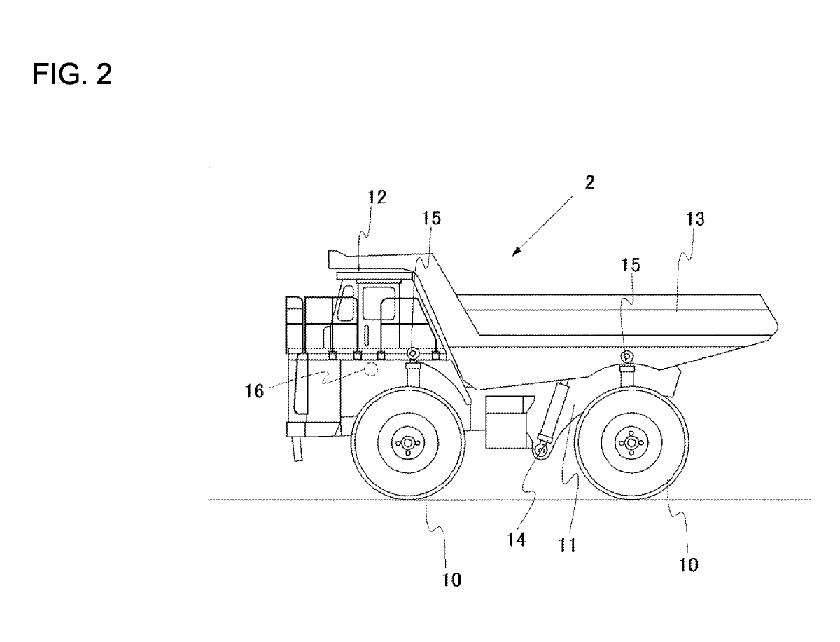

One excavating machine 1 is assigned to plural number of dump trucks 2. In this figure, four dump trucks 1 are assigned to per one excavating machine 1. The dump truck 2 has a construction as shown in FIG. 2. That is, a vehicle body frame 11 which is mounted wheels 10 is provided an operator's cab 12 and a vessel 13. The vessel 13 is loaded excavated substance by the excavating machine 1 runs between the mining field 3 and the dressing site 5, or between the mining field 3 and the dumping site 4.

The dump truck 2 is positioned at the mining field 3 and is loading on the vessel 13 excavated substance by the excavating machine 1. The dump truck 2 thus loaded of excavated substance is transferred through a predetermined root to the dressing site 5 (or to dumping site 4, in a case of useless substance), then the excavated substance is dumped by tilting the vessel 13 toward rearward direction, in other words pursuing dumping action. After then, the vessel 13 is restored to horizontal state and the dump truck 2 travels to return the mining field 3. As a result of the foregoing operation being repeatedly performed, useful ore is extracted from the mining field 3 to feed into the dressing site 5.

The dumping action described above is practiced by actuating a dumping cylinder 14. In addition, a pair of suspension cylinders 15 are connected between the vehicle body frame 11 and the vessel 13 at the left and right positions, thereby exhibiting suspending function. The suspension cylinder 15 has also a function to measure the loaded weight.

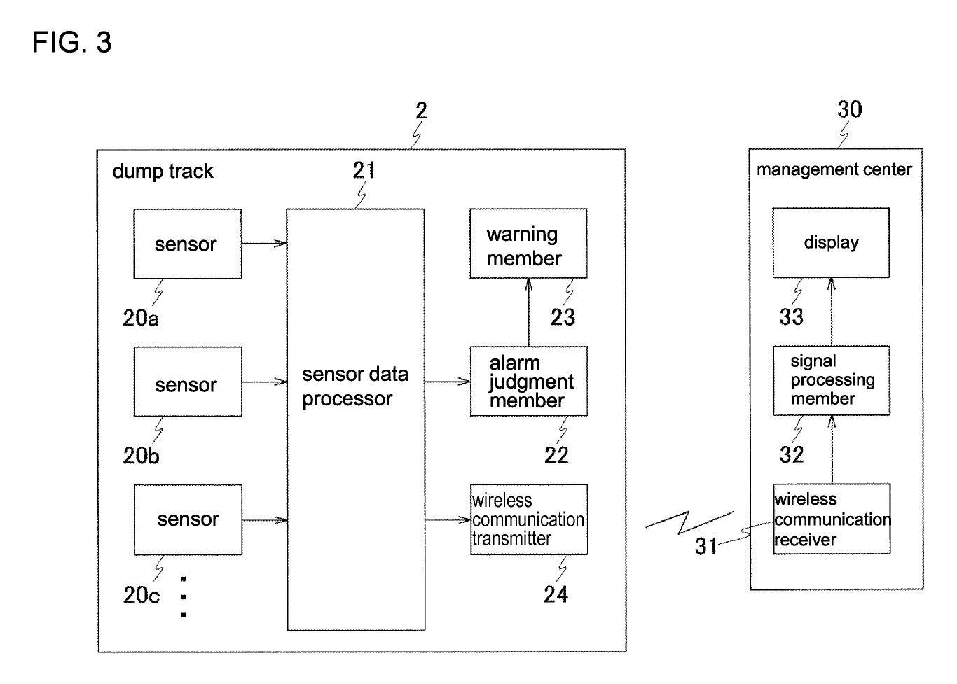

As shown in FIG. 3, the dump truck 2 is mounted various sensors 20a, 20b, 20c, . . . (generally called as reference numeral 20) to detect whether or not respective component parts are operated properly. In this connection, the suspension cylinder 15 sustains the frame 11 so that the weight of the loaded substance of the vessel 13 can be measured by the provision of a load sensor for the suspension cylinder 15. A gyroscope 16 is mounted on the vehicle body frame 11, the gyroscope 16 being adapted to detect the inclination of the dump truck 2. Inclination in the front-rear direction has a meaning that the road surface is inclined or declined toward travelling direction of the dump truck 2, therefore the gyroscope 16 is adapted to detect whether the road ascends slope, namely up hill road, or the road descends slope, namely down hill road, and to detect the inclination angle. The dump truck 2 is provided in the operator's cab 12 of accelerator pedal as one kind of operation members of the vehicle, thus being provided a sensor to detect step-in quantity of the accelerator pedal. Therefore, the load weight of the dump truck 2, upward or downward direction of the inclination of the travelling route and its inclination angle, and travelling speed can be detected by means of the sensors.

The operating conditions of the component parts are monitored by the foregoing various sensors. Detection signals of the sensors 20 are transferred to a sensor data processing section 21 to carry out predetermined signal processes. Since respective sensors are set individual threshold, operation of the dump truck 2 should not bring over the preset threshold. It is set that, in a case where operation is done likely to cause malfunction, the operator can be recognized it. For this purpose, an alarm judging section 22 is connected to the sensor data processing section 21, the alarm judging section 22 doing judgment whether or not generating alarm, when it is required, an alarm is generated from an alarm generating section 23 to notify it to the operator.

A management center 30 is placed at an appropriate place in the field of mining, the management center 30 controls various works comprehensively in the field of mining. The dump truck 2 is installed a wireless communication transmitter 24, this wireless communication transmitter 24 sends data concerning detection values of respective sensors to the management center 30 by means of wireless communication method.

A wireless communication receiver 31 is installed in the management center 30, the various data sent from the wireless communication transmitter 24 of the dump truck 2 are received by the wireless communication receiver 31. A signal processor 32 is connected to the wireless communication receiver 31, the signal processor 32 creates processed data necessary to produce managing images of the dump truck 2 to be displayed on a display 33.

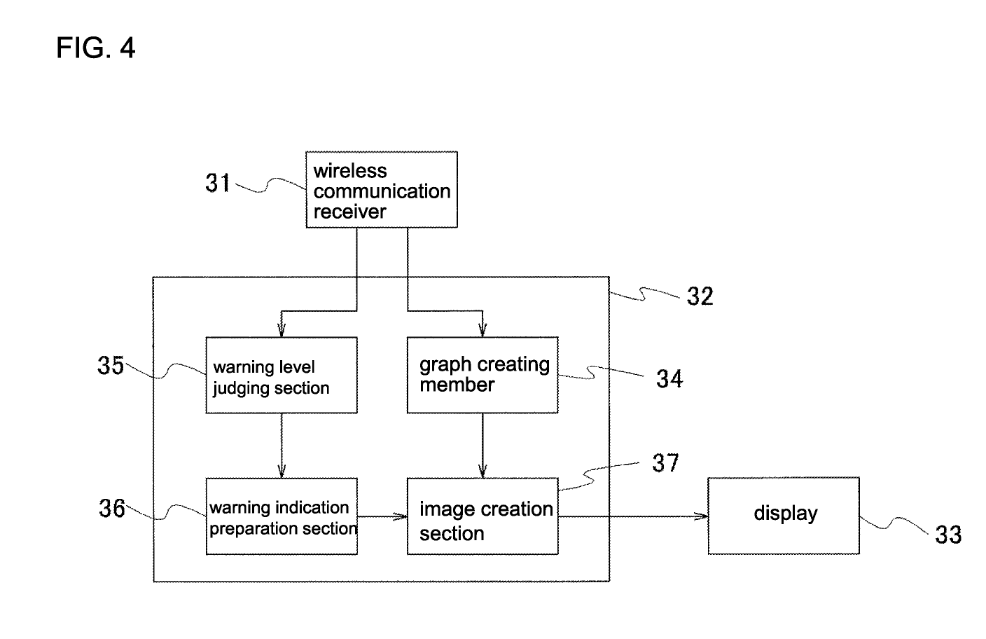

The construction of the signal processor 32 for creating managing image is shown in FIG. 4. The wireless communication receiver 31 receives respective data derived from sensors 20 which are provided at respective working parts and instruments of the dump truck 2 and the like. Then, hereafter explanation is referred to as to travelling management of the dump truck 2 based upon temporal transition on chronological pattern of the following three kind data that is, of difference in height of the travelling rout to be travelled the dump truck 2 obtained from the gyroscope 16, of the weight of load on the vessel 13 detected from the suspension cylinder 15, and of step-in quantity of the accelerator pedal not shown.

The sensor data of the dump truck 2, which are transmitted from the dump truck 2, are received by the wireless communication receiver 31 of the management center 30, thereby the data being captured by a graph creating member 34 to create graphs represented to show load of the vessel 13, inclination on travelling rout of the dump truck 2 and step-in quantity of the accelerator pedal by the operator on temporal transition on chronological pattern.

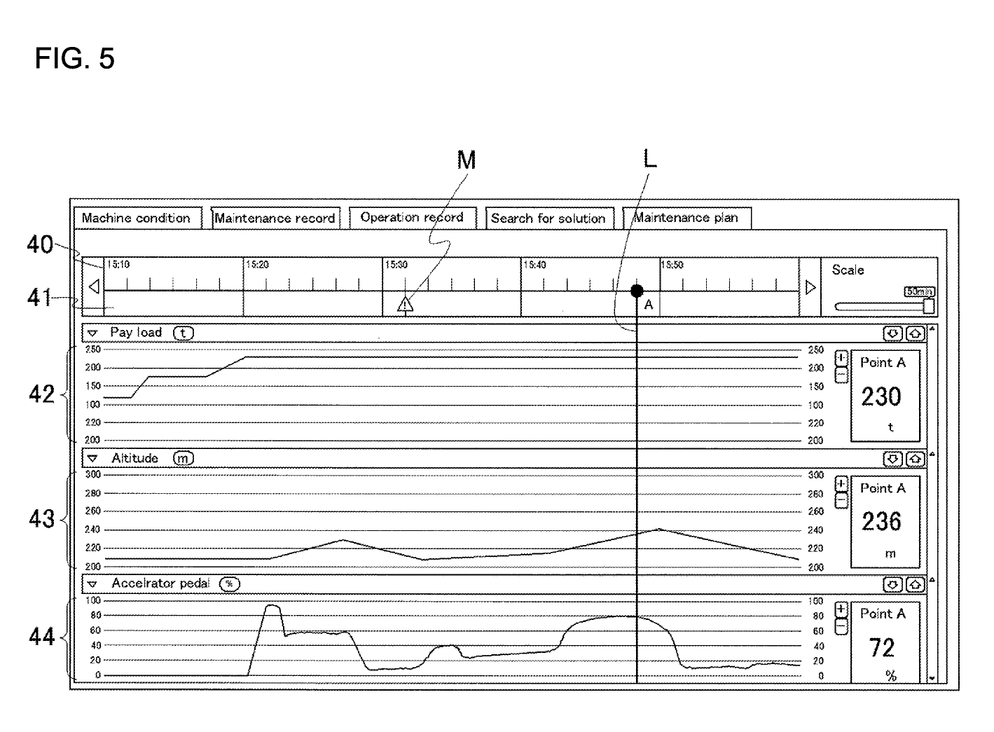

FIG. 5 shows a screen of the display 33 to be shown the above-mentioned respective graphs. The display 33 is divided into plural display regions. In this figure, 40 denotes a time axis indicating region and 41 denotes a warning indicating region 41. The display 33 has also data indicating regions 42, 43 and 44 for displaying the sensor data.

The data indicating region 42 is displayed load weight on the vessel 13 of the dump truck 2. That is, the data indicating region 42 is a region to be display the load weight. The excavated substance is loaded on the vessel 13 in the mining field 3. As a result, the weight of the dump truck 2 becomes to increase during the loading work. In a case where loading of excavated substance is performed by a bucket of the excavating machine 1, thus weight of the dump truck 2 increases stepwise. After completion of loading operation, the dump truck 2 is going to travel. During the travel, the load weight is not changed substantially. However, due to the dump truck 2 travels on irregular ground, the load substance may be dropped out from the vessel 13, such situation causing to reduce the load weight. Therefore, in the situation to reduce of load during travel is found the estimated fact that either any problem is occurred on the operation of the dump truck 2 by the operator, or otherwise on loading work performed by the excavating machine.

The data indicating region 43 is displayed as to inclination of travelling route of the dump truck 2. The right-side end of the display area indicates the loading side position and the left-side end area indicates the unloading side position. In the graph, the portion of line tilted in an ascending direction toward the right means uphill inclination and the portion of line tilted in an descending direction toward the right means downhill inclination. Further, the inclination angle of tilted line expresses the angle of inclined slope of the route. Therefore, even if the dump truck 2 travels at constant speed, not acceleration nor deceleration, travelling speed being increased on travelling downhill inclined slope and travelling speed being decreased on travelling uphill inclined slope.

Further, the data indicating region 44 is displayed temporal transition on chronological pattern of step-in quantity of the accelerator pedal. When increasing the step-in quantity of the accelerator pedal, the dump truck 2 can be accelerated the vehicle speed, as a result causing to increase the fuel consumption correspondingly. Whereas, fuel consumption may be suppressed in a case of maintaining constant speed or travelling reduced speed.

As explained above, by proper operation is performed, on the basis of the load weight of the vessel 13, to the acceleration pedal properly in accordance with ascending and descending inclined road to be travelled, it is ensured to improve the fuel consumption, and to ensure with high speed with low fuel consumption, further to assure stability of the operation, safety and the like. Especially, on the occasion that working is performed in the field of mining, the dump truck 2 operates to travel substantially same rout repeatedly, therefore the efficient transport operation of the dump truck 2 can be attained with least consumption of fuel by properly operating the acceleration pedal of the dump truck 2 on the basis of comprehensive judgment taking in consideration of the load weight of the dump truck 2, tilted angle of uphill and downhill inclined slopes on the way of travelling rout, and the interval between ascended slope and descended slope.

Generally, fuel consumption of a dump truck 2 can be reduced at the time of operation to travel at constant speed in comparison with operating repeatedly acceleration and deceleration during the travel. Therefore, by setting properly constant speed travelling period, accelerating speed period and decelerating speed period on the basis of geographic feature of travelling rout as shown in data on FIG. 5, the operator of the dump truck 2 can be assured to perform actually operating management in a manner for excellent operation with high efficient fuel consumption, and to assure excellent and stable drivability,

Further, line L shown in FIG. 5 denotes a specific time, the situation at the point A of the drawing shows that the dump truck 2 having the load weight of 230 t is travelling at height above sea level 236 m, and step-in quantity of the accelerator pedal being 72%. The foregoing data makes it possible to judge whether or not the dump truck 2 is properly operated during travel of the dump truck 2 in the course of its travelling rout, such as whether or not the load weight is in a suitable state, whether or not the travelling speed is suitable, and the like. In addition, the mark M in the warning indicating region 41 denotes generation of the warning in any portion of the dump truck 2.

### DESCRIPTION OF REFERENCE NUMERALS

1 excavating machine, 2 dump truck, 3 mining field, 4 dumping site, 5 dressing site, 20 sensor, 21 sensor data processor, 22 alarm judgment member, 23 warning member, 24 wireless communication transmitter, 30 management center, 31 wireless communication receiver, 32 signal processing member, 33 display, 34 graph creating section, 35 warning level detecting section, 36 warning indication creating section, 37 image creating section

1. A travel management device of a transport vehicle at a management center in order to perform management of the transport vehicle having a travelling mechanism and a vessel, the transport vehicle being operated with loaded substance on the vehicle to be reciprocally travelled between a predetermined loading field and unloading field, which comprises:
the transport vehicle having at least a load sensor installed in the transport vehicle to measure weight of loaded substance contained in the vessel, inclination sensor to detect inclination angle of the vehicle and an operation amount sensor to detect travelling speed of the vehicle by the operation of a transmission mechanism, further provided with a wireless communication transmitter for transmitting signals detected by the respective sensor;
the management center being provided with a wireless communication receiver to receive transmitted signal from the wireless communication transmitter, and a signal processing apparatus to create plural number of sensor data on the basis of output signal from respective sensors adapted to be displayed plural number of graphs respectively expressed in a form of chronological pattern; and
further the management center having an image displaying apparatus for displaying on a single screen of plural number of related information on the same time axis.

2. A travel management device of transport vehicle according to claim 1, wherein the image displaying member adapted to show in the same chronological pattern of a difference in height of a travelling rout of the transport vehicle, loaded weight of the vessel and temporal transition of detection data of a step-in quantity of accelerator operation, a travelling rout plural kinds of the related information.
